(19) United States
(12) Patent Application Publication
(10) Pub. No.: US 2004/0105112 A1
(43) Pub. Date: Jun. 3, 2004

(54) Printer configuration data setting method and server using the printer configuration data

(76) Inventors: Hisashi Ishihara, Kanagawa (JP); Akio Ishida, Kanagawa (JP)

Correspondence Address: Ivan S. Kavrukov, Esq., Cooper & Dunham LLP, 1185 Avenue of the Americas, New York, NY, 10036, US

(21) Appl. No.: 10/637,683

(22) Filed: Aug. 8, 2003

(30) Foreign Application Priority Data
Aug. 9, 2002 (JP) 2002-233529

(51) Int. Cl. G06F 3/12; G06F 15/00; G06F 13/10; G06F 19/00

(52) U.S. Cl. 358/1.13; 358/1.15; 719/327; 710/8

(57) ABSTRACT

A method for setting configuration data of a printer for a printer driver in a server of an image printing system that includes a client, printers and the server including the printer driver for the printer is provided, in which configuration data obtained from printers is stored into the server as configuration data files each of which corresponds to a condition, and a part in the server determines which configuration data file to access according to the condition, determines which piece of data to obtain from the configuration data file according to request from the printer driver, accesses and obtains the piece of data, and sends the piece of data to the printer driver.

### BACKGROUND OF THE INVENTION

1. Field of the Invention

The present invention relates to technology for reflecting configuration data of a printer on a printer driver in a server used for server-based environment (for example, “Metaframe” environment) in which applications run only in the server.

2. Description of the Related Art

To solve problems of a conventional client/server system, there is a system in which application programs run only in a server instead of in clients. A system introducing the Metaframe server is an example of such a system.

FIG. 1 shows an example of the Metaframe environment. An application program run on an Metaframe server 1, and a client 2 only displays execution results of tho application program.

To use a printer 3 in the Metaframe environment, for example, a printer driver is installed in the Metaframe server 1 beforehand, and a logical printer of the printer 3 is auto-created when the client 2 that uses the printer 3 logs to the Metaframe server 1. When printing is performed from the client 2, print data is generated in the Metaframe server 1, and the print data is redirected to the printer 3 via the client 2, so that the printer 3 prints the print data. According to the printer auto creation in the Metaframe environment, although the application is running only in the server, the user can print from the application running on the Metaframe server 1 to her local printers, just like she can print from local applications. For example, “Inside Citrix Metaframe XP” of Addison-Wesley refers to the printer auto-creation process in more detail.

In addition, U.S.2002/0018234A1 discloses a conventional technology of a Metaframe print system. The U.S.2002/0018234A1 discloses a universal printer driver that can be used in the Metaframe environment.

In the printer system of the Metaframe environment, there is a problem in that, although printer options are set in the client side printer driver, the option setting is not reflected on the printer driver in the Metaframe server side in the printer auto-creation process.

That is, option setting in the logical printer remains default setting. For example, even if the printer has a double-sided tray, the setting of the auto-created logical printer remains no double-sided tray. In addition, settings for paper size and paper type of tray remain default.

An object of the present invention is to provide technology to reflect configuration data of a printer on a printer driver on the server in an environment in which application programs run only on the server instead of on clients, and to store configuration data efficiently in the server.

The above object is achieved by a method for setting configuration data of a printer for a printer driver in a server of an image printing system that includes a client, printers and the system including the printer driver for the printer, the method including the step of:

storing configuration data obtained from printers into the server as configuration data files each of which corresponds to a condition;

wherein a configuration data obtaining part in the server determines which configuration data file to access according to the condition, determines which piece of data to obtain from the configuration data file according to a request from the printer driver, access and obtains the piece of data, and sends the piece of data to the printer driver.

According to the present invention, configuration data can be reflected on the printer driver in the server in an environment in which the configuration data cannot be obtained by using bidirectional communication. Especially, according to the present invention, since the configuration data files are stored in the server for each condition, data amount of configuration data to be stored can be decreased, and configuration data can be managed easily.

### BRIEF DESCRIPTION OF THE DRAWINGS

Other objects, features and advantages of the present invention will become more apparent from the following detailed description when read in conjunction with the accompanying drawings, in which:

FIG. 1 shows an example of a Metaframe environment;

FIG. 2 shows a normal configuration including the client 2 and the printer 3;

FIG. 3 is a figure for explaining bidirectional communication according to a conventional technology:

FIG. 4 is a figure showing a network configuration according to the embodiment of the present invention;

FIG. 5 shows a software module configuration in the Metaframe server 1 (enclosed by a solid line square) according to an embodiment of the present invention;

FIG. 6 is a figure for explaining a method for determining which file to select from among a plurality of configuration data files;

FIG. 7A is a figure for explaining how to obtain configuration data by the client 2;

FIG. 7B is a figure for explaining how to obtain configuration data by the printer driver;

FIG. 8 shows an example of a window displayed on a client display by the configuration data obtaining tool;

FIG. 9 shows a flowchart of a procedure for reflecting configuration data on the printer driver in the server;

FIG. 10 is a flowchart for selecting a proper configuration data file from among a plurality of configuration data files and obtaining configuration data from the selected configuration data file;

FIG. 11A shows the configuration of the conventional network communication module 6;

FIG. 11D shows the configuration of the pseudo network communication module 7 of an embodiment of the present invention;

FIG. 12 shows an example of the content of the related information file;

FIG. 13 is a figure for explaining the relationship between the pseudo network communication module and the configuration data obtaining method of the present invention;

FIG. 14 is a figure for explaining an embodiment for obtaining configuration data of a plurality of printers at once.

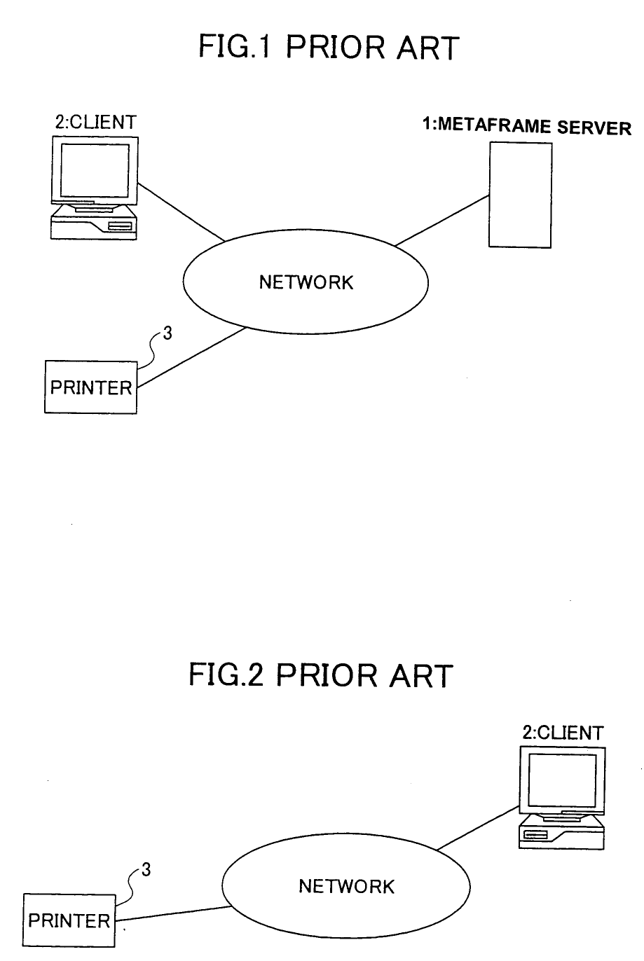

### DETAILED DESCRIPTION OF THE PREFERRED EMBODIMENTS

As described in the related art, there is a problem in that option setting in the printer driver in the client side is not inherited to the printer driver in the Metaframe server. The reason at the problem will be described in the following.

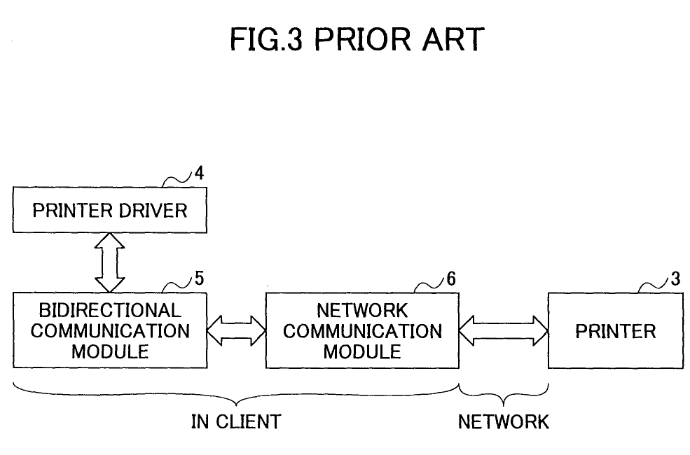

In a normal configuration including the client 2 and the printer 3 shown in FIG. 2, the client 2 and the printer 3 performs bidirectional communication so that option data such as the double-sided tray of the printer 3 can be obtained by the client 2. The bidirectional communication is performed, for example, in a configuration shown in FIG. 3. In this configuration, a network communication module 6 obtains information specified by a bidirectional communication module 5 from the printer 3 via a network by using a protocol such as SNMP, in which the bidirectional communication module 5 is a part of the printer driver 4.

However, the above-mentioned bidirectional communication is not available between the Metaframe server 1 and the printer 1 in the Metaframe environment. Therefore, the option data can not be obtained by the printer driver in the Metaframe server, Thus, the above-mentioned problem arises.

In the following, embodiments of the present invention will be described.

(Outline of Configuration)

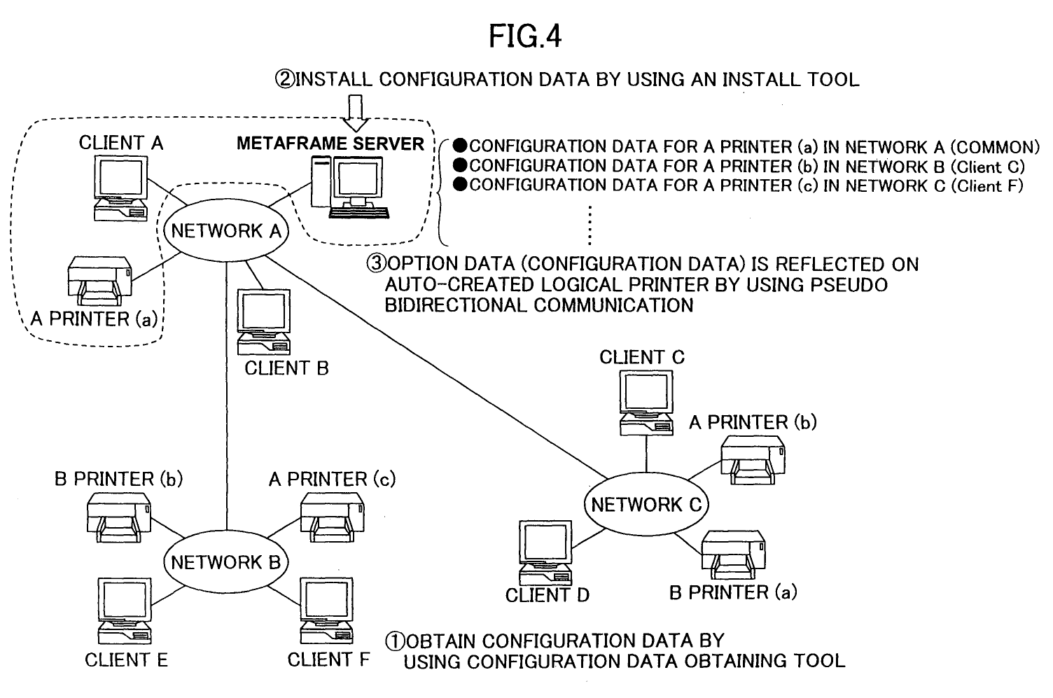

FIG. 4 is a figure showing a network configuration according to the embodiment of the present invention. Configuration data such as tray information can not be obtained by the Metaframe server by using the bidirectional communication. Thus, in the present invention, as shown in FIG. 4, configuration data of each printer is obtained by using a configuration data obtaining tool that is installed in a client or in the Metaframe server. Then, the obtained configuration data is stored in the Metaframe server.

The Metaframe server 1 accesses the data so that the printer driver in the Metaframe server obtains the configuration data, and the configuration data can be reflected on the option setting in the auto-created

In a network environment in which there are a plurality of clients and a plurality of printers as shown in the configuration shown in FIG. 4, configuration data are stored in the Metaframe server for each client and for each printer. By storing configuration data for each in such a way, data amount can be decreased and work load for managing the configuration data can be decreased compared with storing configuration data for each logical printer that is auto-created. This method will be described in more detail later.

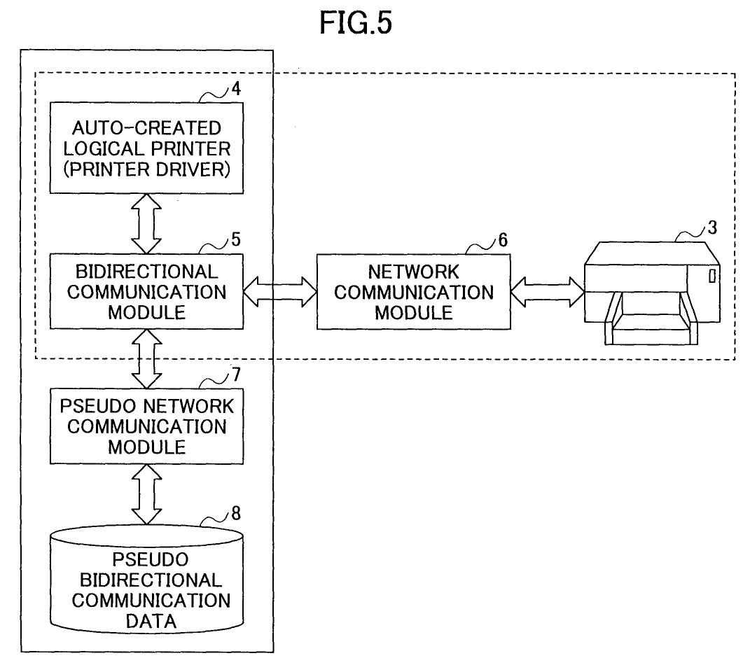

FIG. 5 shows a software module configuration in the Metaframe server 1 (enclosed by a solid line square). For comparison, a conventional configuration is shown in a dotted line square.

As shown in FIG. 5, the network communication module 6 is not used, but, a pseudo network communication module 7 is used. Accordingly, the printer driver 4 obtains, via the pseudo network communication module 7, necessary pieces of configuration data from the pseudo bidirectional communication data 8 that is stored beforehand

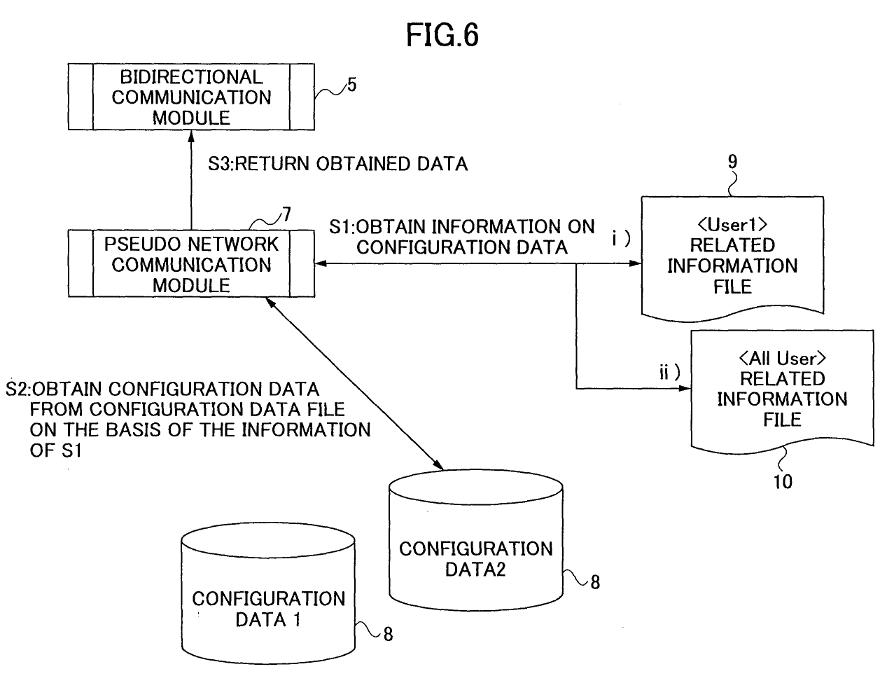

FIG. 6 is a figure for explaining a method for determining which file to select from among a plurality of configuration data files.

As mentioned above, in this embodiment, the configuration data files can be stored in the Metaframe server, for example, for each client, each printer model, icon name and the like. Information used for determining which configuration data file to use is stored as related information files 9 and 10.

In this configuration, the pseudo network communication module 7 receives a request to obtain configuration data via the bidirectional communication module from the printer driver. Then, in response to the request, the pseudo network communication module 7 refers to the related information file and obtains information indicating a file to be used in step 1. Then, the pseudo network communication module 7 obtains configuration data by accessing a proper configuration data file according to the information in step 2, and returns the obtained configuration data to the bidirectional communication module 5 in step 3.

In the example shown in FIG. 6, there are provided two types of related information files. One is for common use for all users. Another is provided for each user. The reason for providing the two types of related information files is that some users may not access directories of the Metaframe server, and that some users may want to prohibit other users to access setting values. That is, the related information files are divided into files for each user and files common to every user.

(Flow of Processing)

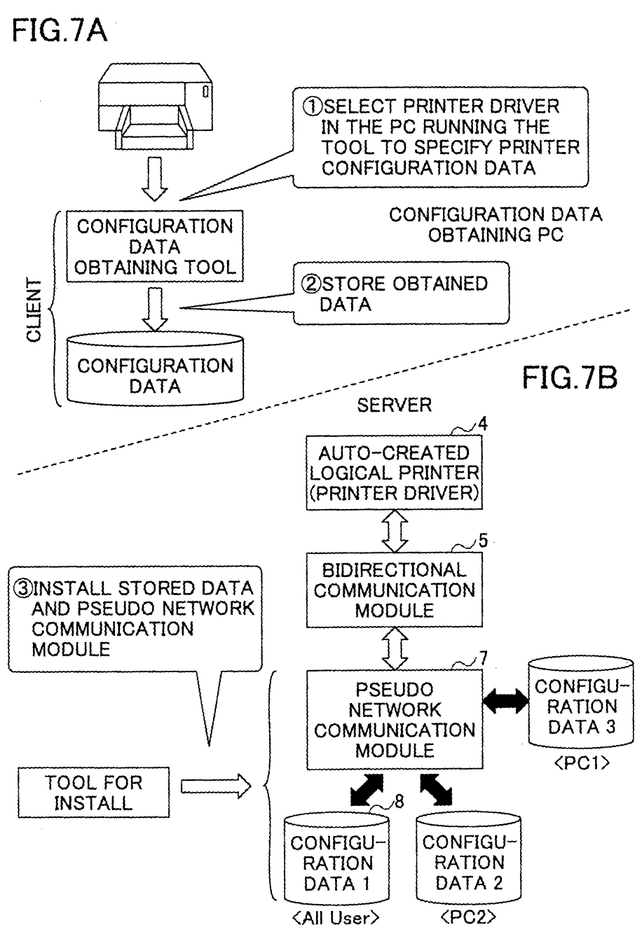

Next, processing in the present embodiment will be described in more detail with reference to FIGS. 7-9.

FIG. 7A is a figure for explaining how to obtain configuration data by the client 2. As shown In the figure, the client 2 in which the configuration data obtaining tool runs obtains the configuration data.

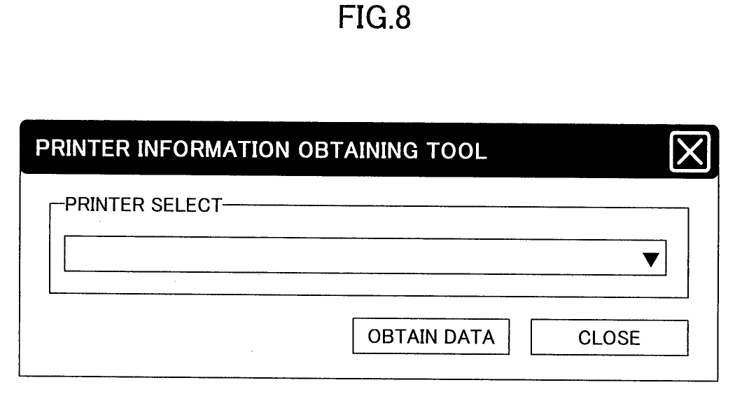

At this time, for example, the client 2 displays a window shown in FIG. 8 so that the user of the client 2 selects a printer driver installed in the client 2. As a result, a printer from which configuration data is to be obtained to specified. Then, the client obtains data from the specified printer and stores the obtained data. The mechanism for obtaining the configuration data by using the configuration data obtaining tool is the same as the mechanism in which configuration data is obtained by a printer driver (bidirectional communication module) and the network communication module as shown in FIG. 3.

The configuration data obtaining tool can be also installed in a server instead of in a PC as long as a printer driver for the target printer is installed in the server or the PC. In addition, each client may obtain configuration data of printers connected to the client. Further, a specific client of the Metaframe server may obtain configuration data at once for all targeted printers.

Next, as shown in FIG. 7D, the configuration data 8 and the pseudo network communication module 7 are installed in the Metaframe server 1 by copying the configuration data 8 and the pseudo network communication module 7 in a predetermined folder in the Metaframe server 1. The pseudo network communication module 7 may be installed beforehand

It is also possible to store the configuration data 8 in the client 2 so that the Metaframe server 1 obtains the data via a network. However, since it is desirable to decrease data amount transmitted over the network in the Metaframe environment, the configuration data in stored in the server 1 according to the present embodiment.

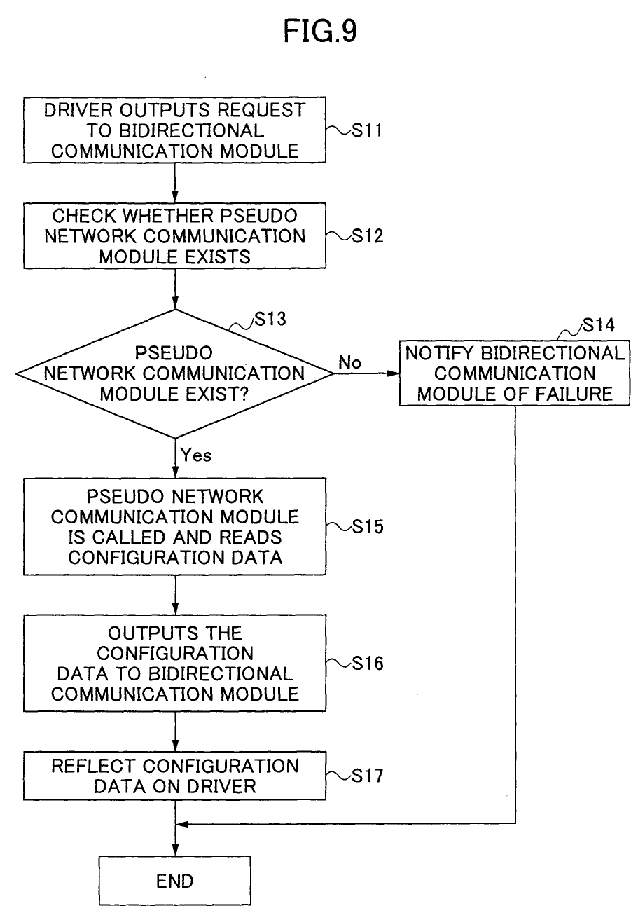

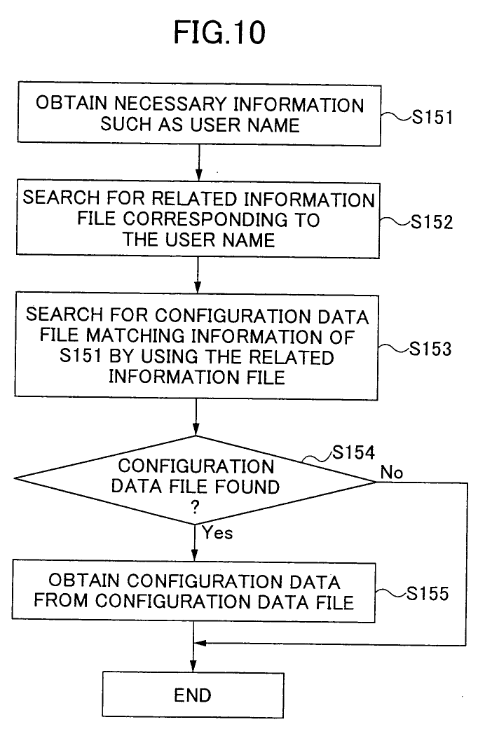

Next, procedure for reflecting configuration data on the printer driver in the server will be described with reference to FIGS. 9 and 10. The following processing can be performed when the logical printer is auto-created, or when the user of the client opens a property screen of the printer driver after the logical printer is created.

In FIG. 9., first, the printer driver outputs an option data obtaining request to the bidirectional communication module 5 in step 11. The option data obtaining request includes an instruction indicating which items of configuration data to obtain such as tray information and the like. Next, the bidirectional communication module 5 checks whether the pseudo network communication module 7 exists in step 12.

If the pseudo network communication module 7 does not exist (NO in step 13), the server notifies the bidirectional communication module 5 that the process fails in step 14, and the process ends. If the pseudo network communication module 7 exists (Yes in step 13), the pseudo network communication module 7 is called and the pseudo network communication module 7 obtains configuration data corresponding to the option data obtaining request from the configuration data file 8 in step 15. After that, the read data is output to the bidirectional communication module 5 in step 6. The obtained configuration data is reflected on setting of the printer driver in step 17.

(Details for Configuration Data File Selection Process)

In the above mentioned step 15, the pseudo network communication module selects a proper configuration data file from among a plurality of configuration data file and obtains configuration data from the selected configuration data file. The detailed process will be described with reference to FIG. 10. Tho process shown in FIG. 10 assumes the case where the related information files are stored for each user.

In FIG. 10, the pseudo network communication module 7 obtains necessary information including user name, client name, printer model and the like from information from the bidirectional communication module in step 151. Then, on the basis of the obtained user name, the pseudo network communication module searches for a related information file for the user in stop 152. Then, by referring to the related information file, the pseudo network communication module searches, in step 153, for a configuration data file that matches the pieces of the information obtained in step 151. If the configuration data file is not found (No in step 154), the process ends. If the configuration data file is found (Yes in step 154), the pseudo network communication module 7 obtains configuration data included in the configuration data file in step 155.

(Details of the Pseudo Network Communication Module and the Related Information File)

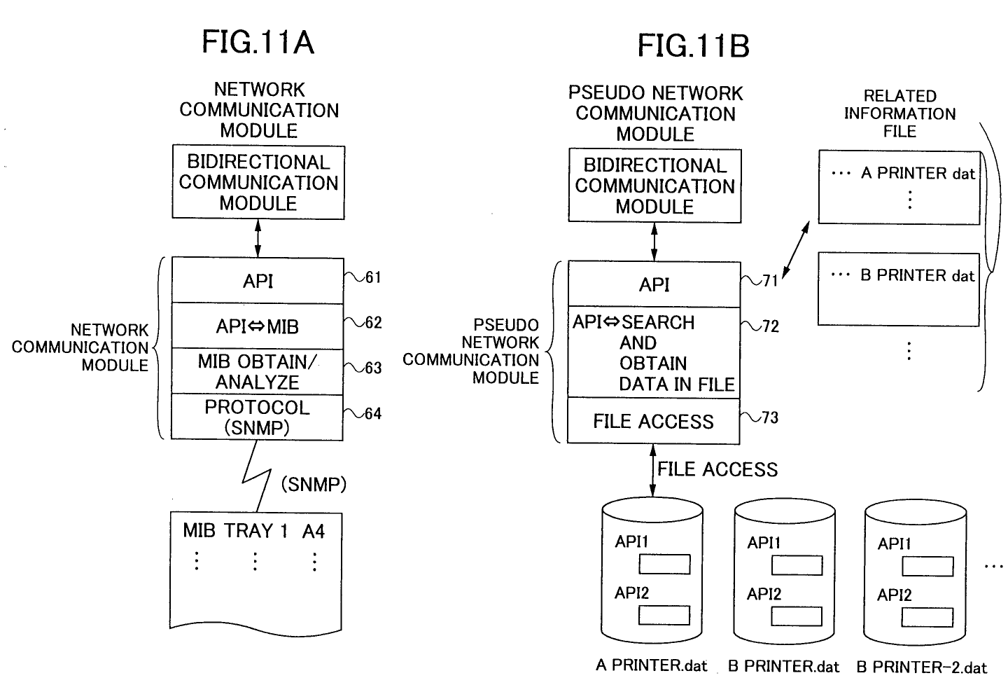

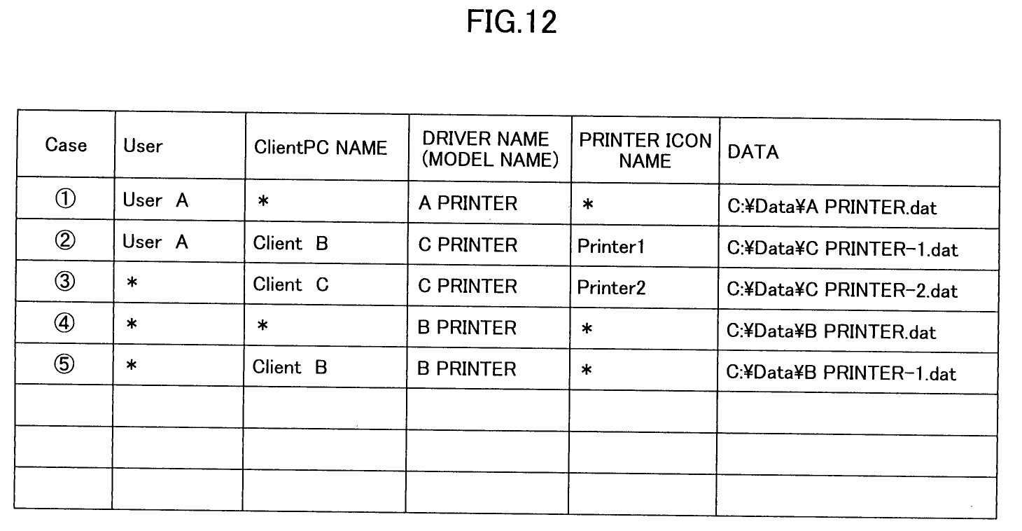

Next, the configuration of the pseudo network communication module will be described in detail, in which the pseudo network communication module is compared with the normal network communication module with reference to FIGS. 11A, 11B and 12.

FIG. 11A shows the configuration of the conventional network communication module. FIG. 11B shows the configuration of the pseudo network communication module of the present embodiment.

As shown in FIG. 11A, the conventional network communication module includes API (application program interface) 61, a converting part 62, a MIB obtaining/analyzing part 63, and a protocol implemented part 64. The API 61 is for interfacing between the application program for specifying information to be obtained and the network communication module 6. The API is a set of functions, for example, each of which corresponds to a piece of MIB data. The function itself may be called as an API. The converting part 62 converts between information specified by the application via API and MIB data. The MIB obtaining/analyzing part 63 obtains and analyzed MIB data on the printer. According to this configuration, the network communication module can obtain configuration data (option data) that is MIB data by using bidirectional communication.

As shown in FIG. 11D, the pseudo network communication module includes API 71 that is the same as that of the conventional network communication module. In addition, the pseudo network communication module includes a file search/data obtaining part 72 and a file accessing part 73. The file search/data obtaining part 72 determines which piece of configuration data to obtain in the configuration data file according to information specified by the API 71 and searches the file and obtains the piece of configuration data. The file accessing part 73 In addition, the file search/data obtaining part 72 has capabilities for determining a related information the by using a user name obtained from the bidirectional communication module, searching the related information file, and determining which configuration data file to access by using information obtained from the bidirectional communication module and the related information file.

In the configuration shown in FIG. 11B, the API 71 and the API 61 are the same. Thus, from the viewpoint of the bidirectional communication module, the pseudo network communication module and the network communication module appear to be the same. Therefore, a printer driver same as a conventional printer driver can be used in the Metaframe server according to the present invention.

The pseudo network communication module can be stored in a recording medium such as an IC card, CD-ROM and the like, so that the pseudo network communication module can be installed in the server from the recording medium The pseudo network communication module can be also installed in the server via a network.

FIG. 12 shows an example of the content of the related information file. In this embodiment, each of a set of the cases (1) and (2), and a set of the cases (3) to (5) is stored in a related information file. However, a related information file including all of the records shown in FIG. 12 can be also used

In the example shown in FIG. 12, storing locations of configuration data files can be managed for each user, each connected client terminal, each printer driver frame (corresponding to printer model) and each printer icon name. The pseudo network communication module compares pieces of information obtained from the bidirectional communication module with information in the related information file, wherein the pieces of information obtained from the bidirectional communication module includes user identification data, connected client terminal identification data, printer driver (printer model) identification data, icon identification data and the like. Then, the pseudo network communication module A configuration data the that corresponds to pieces of information in a record, in the related information file, that matches the obtained pieces of information. The user name can be identified by a login ID, for example. The client terminal can be identified by the IP address. In addition, the Metaframe server can identify the printer driver name and the icon name since these are sent to the server from the client terminal when the user selects a printer on the screen of the client, for example.

In FIG. 12, * (wild card) means that it matches any data as to the filed data item. However, if a specific value is set in other records for the filed item and if obtained data matches the specific value, the record including the specific value precedes the record including the wild card. For example, as to field item of “User”, if obtained data is User A, cases (1) and (2) precedes cases (3) to (5) as for the item “User”.

In FIG. 12, a case in which “User A” prints something from “Client B” by using “C printer” and rising printer icon “Printer1” matches the case (2). Thus, the pseudo network communication module accesses C:¥Data¥Cprinter-1.dat so as to obtain configuration data from this the.

A case file which “User A” prints something from “Client B” by using “A printer” and using printer icon “Printer” does not match the case (2), but matches the case (1). Thus, the pseudo network communication module refers to C:¥Data¥Aprinter.dat.

In addition, a case in which “user A” prints something from “Client B” by using “D printer” matches the case (S). Thus, the pseudo network communication module refers to C:¥Data¥Bprinter-1.dat.

Since each configuration data file depends on the printer driver (printer model), the printer driver name (printer model) is essential data. For example, the configuration data for A printer can not be used for B printer. As to other data items, the wild card can be used.

(Relationship Between the Pseudo Network Communication Module and the Configuration Data Obtaining Method)

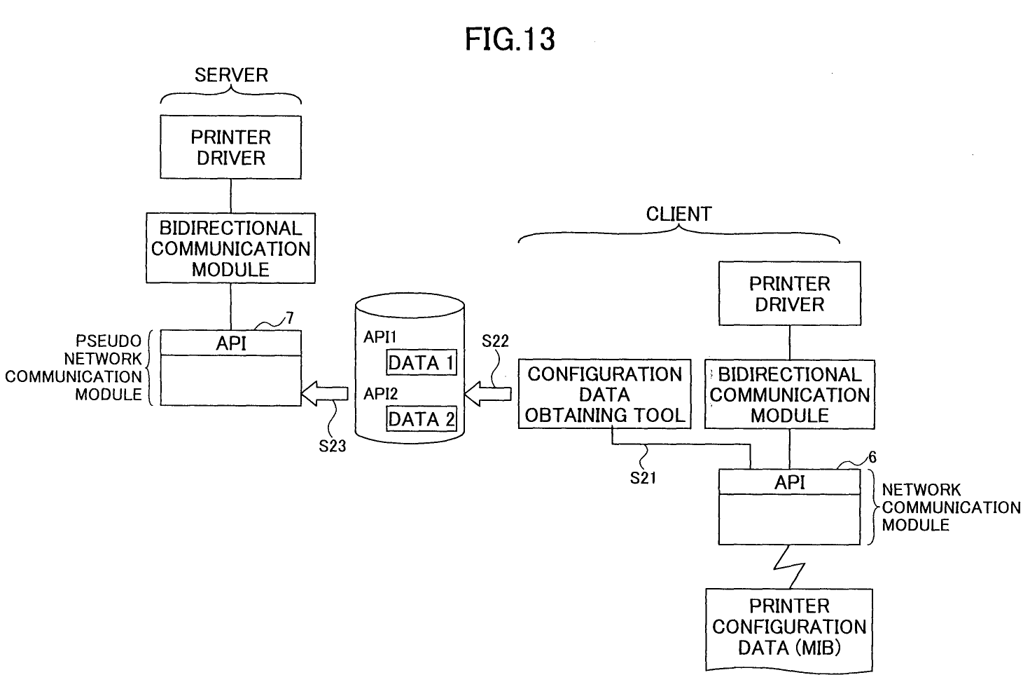

Next, the relationship between the pseudo network communication module and the configuration data obtaining method will be described with reference to FIG. 13.

As mentioned before the configuration data is obtained by the client by using a software configuration similar to that for performing conventional bidirectional communication. That is, as shown in client side configuration in FIG. 13, the configuration data obtaining tool obtains configuration data by using SNMP via APIs In the network communication module 6. Since the configuration data is obtained by using the conventional APIs, the configuration data can be obtained API by API. Thus, data file in which configuration data includes API by API is stored in the Metaframe server as the configuration data file.

For obtaining the configuration data in the client, the configuration obtaining tool calls all APIs in step 21, and obtains configuration data (parameters) corresponding to the APIs and stores the configuration data as the configuration data file in step 22, in which each piece of the configuration data is associated with a corresponding API. This processing is performed, for example, for each printer.

By storing the configuration data in such a format, the pseudo network communication module 7 in the server can use APIs same as the APIs that are conventionally used in a printer driver in the client. Thus, the pseudo network communication module 7 can read, from the configuration data file, pieces of configuration data requested by the bidirectional communication module in the printer driver in the Metaframe server, and can return the pieces of configuration data to the bidirectional communication module in step 23. The pseudo network communication module 7 can read the pieces of configuration data without changing the configuration data

Locations and file names of the configuration data files to be stored in the server are determined such that the locations and the file names are consistent with content in related information files.

(Embodiment for Obtaining Configuration Data of a Plurality of Printers at Once)

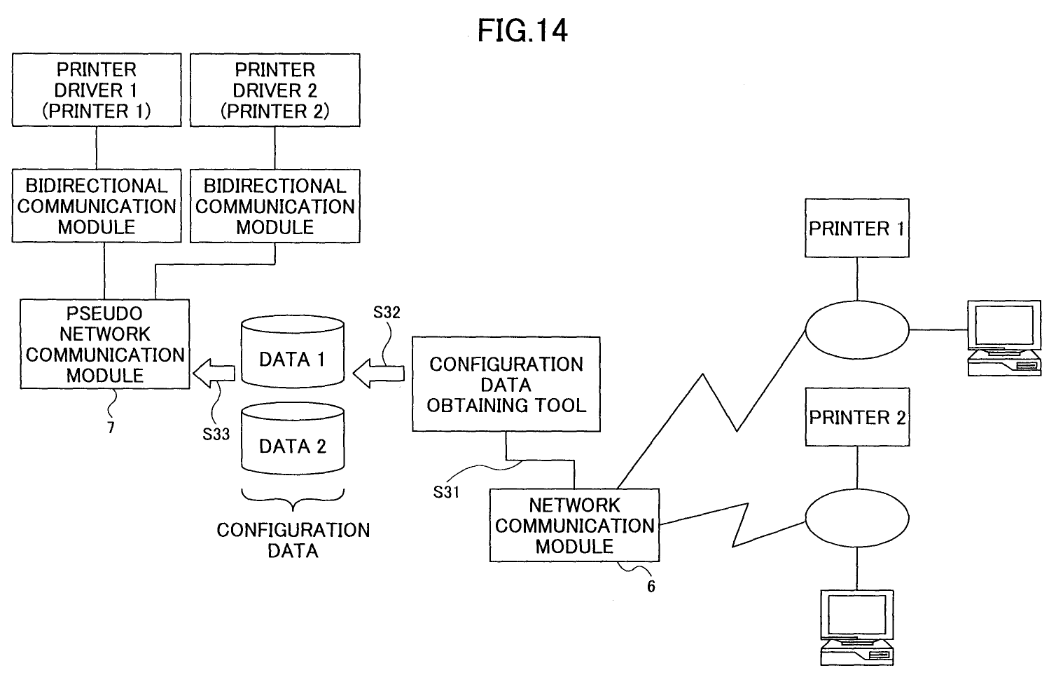

As shown in FIG. 14, configuration data can be obtained from a plurality of printers at once from a client or a server. In the configuration shown in FIG. 14, a configuration data collectively obtaining tool obtains configuration data of printers, in which the printers are specified by the user or are found automatically by the a configuration data collectively obtaining tool in step 31. Then, files of the configuration data are stored in the Metaframe server, in which the file names and the locations (folders) are determined such that the file names and the locations are consistent with content of the related information files in step 32. Then, by the method described so far, the pseudo network communication module 7 accesses an appropriate configuration data file, obtains configuration data and returns the configuration data to the bidirectional communication module in step 33.

As mentioned above, according to the present invention, a method for setting configuration data of a printer for a printer driver in a server of an image printing system that includes a client, printers and the server including the printer driver for the printer is provided, in which configuration data obtained from printers are stored into the server as configuration data files each of which corresponds to a condition; and the configuration data obtaining part in the server determines which configuration data file to access according to the condition, determines which piece of data to obtain from the configuration data file according to a request from the printer driver, accesses and obtains the piece of data, and sends the piece of data to the printer driver.

According to the present invention, option setting such as tray and double aided unit information can be reflected on the printer driver in the Metaframe server, that is, reflected on the auto-created logical printer from the viewpoint of the user, so that the user can perform option setting. Especially, in an environment in which plurality of terminals are connected as shown in FIG. 4, if configuration data in stored for each logical printer to be auto-created, data amount becomes large so that management work load increases. On the other hand, according to the present invention, since the related information file as shown in FIG. 12 is used, the server can store only necessary configuration data, so that data amount and management cost can be decreased.

In the method, the condition may be determined by one or more of items of a user who uses the printer, a client in which printing is performed, a model of the printer, and a printer icon used in the client. Thus, for example, when user A uses a specific printer from client B, configuration data corresponding to this condition is reflected on the printer driver.

In addition, the server includes related information that includes conditions and names of the corresponding configuration date files; and the configuration data obtaining part determines a configuration data file that matches a condition obtained from the client by referring to the related information.

The related information may include, as a condition, one or more items of a user who uses the printer, a client In which printing is performed, a model of the printer, and a printer icon used in the client. By using such related information, the related information is consistent with configurations data files stored in the server, so that proper configuration data file can be used. The server may include related information files for each user and related information files common to every user.

In the method, an application program interface between the configuration data obtaining part and the printer driver in the server is the same as an application program interface between a network communication module and a client printer driver same as the printer driver in the server, in which the network communication module is used for obtaining configuration data of the printer for the client printer driver in a client terminal. Accordingly, even by using a conventionally used printer driver in the server, the configuration data can be reflected on the printer driver.

In the method, the configuration data obtaining part may include; the application program interface; a part for determining which piece of configuration data to obtain from the configuration data file on the basis of information from the application program interface; and a part for accessing the on; figuration data file and reads the determined piece of configuration data. Thus, the configuration data obtaining part can be realized by a simple configuration compared with a conventional network communication module.

In the method, wherein the configuration data to be stored in the server is obtained from printers by using a network communication module that performs bidirectional communication with the printers.

Thus, by using API that is the same as API of the network communication module for the configuration data obtaining part, the configuration data obtaining part can use the stored configuration data without any change. The configuration data obtaining part corresponds to the pseudo network communication module.

In addition, the configuration data can be obtained at once for all printers that can be used by the server or the client. Therefore, load for obtaining configuration data can be decreased.

The present invention is not limited to the specifically disclosed embodiments, and variations and modifications may be made without departing from the scope of the present invention.

What is claimed is:

1. A method for setting configuration data of a printer for a printer driver in a server of an image printing system that includes a client, printers and the server including the printer driver for the printer, the method comprising the step of:
storing configuration data obtained from printers into the server as configuration data files each of which corresponds to a condition;
wherein a configuration data obtaining part in the server determines which configuration data file to access according to the condition, determines which piece of data to obtain from the configuration data file according to a request from the printer driver, accesses and obtains the piece of data, and sends the piece of data to the printer driver.

2. The method as claimed in claim 1, wherein the condition is determined by one or more of items of a user who uses the printer, a client in which printing is performed, a model of the printer, and a printer icon used in the client.

3. The method as claimed in claim 1, wherein the server includes related information that includes conditions and names of the corresponding configuraton data files; and
the configuration data obtaining part determines a configuration data the that matches a condition obtained from the client by referring to the related information.

4. The method as claimed in claim 3, wherein the related information includes, as a condition, one or more items of a user who uses the printer, a client, in which printing is performed, a model of the printer, and a printer icon used in the client.

5. The method as claimed in claim 3, wherein the server includes related information files for each user and related information files common to every user.

6. The method as claimed in claim 1, wherein an application program interface between the configuration date obtaining part and the printer driver in the server is the same as an application program interface between a network communication module and a client printer driver same as the printer driver in the server, in which the network communication module is used for obtaining configuration data of the printer for the client printer driver in a client terminal.

7. The method as claimed in claim 6, the configuration data obtaining part comprising:
the application program interface;
a part for determining which piece of configuration data to obtain from the configuration data file on the basis of information from the application program interface; and
a part for accessing the configuration data file and reads the determined piece of configuration data.

8. The method as claimed in claim 1, wherein the configuration data to be stored in the server is obtained from printers by using a network communication module that performs bidirectional communication with the printers.

9. The method as claimed in claim 8, the configuration data is obtained at once for all printers that can be used by the server or the client.

10. The method as claimed in claim 1, wherein the server is used for realizing server-based computing in which application processing is handled by the server and not by the client.

11. A server to be used in an image printing system that includes a client, printers and the server including a printer driver for a printer, the server comprising:
a part for storing configuration data obtained from printers as configuration data files each of which corresponds to a condition; and
a configuration data obtaining part that determines which configuration data file to access according to the condition, determines which piece of data to obtain from the configuration data file according to a request from the printer driver, accesses and obtains the piece of data, and sends the piece of data to the printer driver.

12. The server as claimed in claim 11, wherein the condition is determined by one or more of items of a user who uses the printer, a client in which printing is performed, a model of the printer, and a printer icon used in the client.

13. The server as claimed in claim 11, wherein the server includes related information that includes conditions and names of the corresponding configuration data files; and
the configuration data obtaining part determines a configuration data file that matches a condition obtained from the client by referring to the related information.

14. The server as claimed in claim 13, wherein the related information includes, as a condition, one or more items of a user who uses the printer, a client in which printing is performed, a model of the printer, and a printer icon used in the client.

15. The server as claimed in claim 13, wherein the server includes related information files for each user and related information files common to every user.

16. A program to run on a server to be used in an image printing system that included a client, printers and the server including a printer driver for a printer, wherein configuration data obtained from printers is stored in the server as configuration data files each of which corresponds to a condition, the program comprising:
configuration data obtaining program code means that determines which configuration data file to access according to the condition, determines which piece of data to obtain from the configuration data file according to a request from the printer driver, accesses and obtains the piece of data, and sends the piece of data to the printer driver.

17. The program as claimed in claim 16, wherein the condition is determined by one or more of items of a user who uses the printer, a client in which printing is performed, a model of the printer, and a printer icon used in the client.

18. The program as claimed in claim 16, wherein the server includes related information that includes conditions and names of the corresponding configuration data files; and
the configuration data obtaining program code means determines a configuration data file that matches a condition obtained from the client by referring to the related information.

19. The program as claimed in claim 18, wherein the related information includes, as a condition, one or more items of a user who uses the printer, a client in which printing is performed, a model of the printer, and a printer icon used in the client.

20. A computer readable medium storing a program to run on a server to be used in an image printing system that includes a client, printers and the server including a printer driver for a printer, wherein configuration data obtained from printers is stored in the server as configuration data files each of which corresponds to a condition, the program comprising:
configuration data obtaining program code means that determines which configuration data file to access according to the condition, determines which piece of data to obtain from the configuration data file according to a request from the printer driver, accesses and obtains the piece of data, and sends the piece of data to the printer driver.

21. The computer readable medium as claimed in claim 20, wherein the condition is determined by one or more of items of a user who uses the printer, a client in which printing is performed, a model of the printer, and a printer icon used in the client.

22. The computer readable medium as claimed in claim 20, wherein the server includes related information that includes conditions and names of the corresponding configuration data files; and
the configuration data obtaining program code means determines a configuration data file that matches a condition obtained from the client by referring to the related information.

23. The computer readable medium as claimed in claim 22, wherein the related information includes, as a condition, one or more items of a user who uses the printer, a client in which printing is performed, a model of the printer, and a printer icon used in the client.
